(19) United States
(12) Patent Application Publication
(10) Pub. No.: US 2025/0097938 A1
(43) Pub. Date: Mar. 20, 2025

(54) WIRELESS COMMUNICATION METHOD, USER EQUIPMENT, AND BASE STATION

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 18/949,826

(22) Filed: Nov. 15, 2024

Related U.S. Application Data
(63) Continuation of application No. PCT/CN2023/106560, filed on Jul. 10, 2023.
(60) Provisional application No. 63/397,600, filed on Aug. 12, 2022.

(51) Int. Cl. H04W 72/1268; H04L 5/00

(52) U.S. Cl. CPC H04W 72/1268; H04L 5/0053

(57) ABSTRACT

A user equipment (UE) executes a wireless communication method. A set of transmission/reception points (TRPs) transmits first uplink scheduling and a second uplink scheduling to the UE. The UE receives a first uplink scheduling and a second uplink scheduling and performs a first uplink transmission using the first uplink scheduling and a second uplink transmission using the second uplink scheduling. The first uplink transmission and the second uplink transmission are simultaneously transmitted via multiple transmit panels.

### CROSS-REFERENCE TO RELATED APPLICATION

This application is a continuation of International Application No. PCT/CN2023/106560, filed Jul. 10, 2023, which claims priority to U.S. Provisional Patent Application No. 63/397,600, filed Aug. 12, 2022, the entire disclosures of which are incorporated herein by reference.

### TECHNICAL FIELD

The present disclosure relates to the field of communication systems, and more particularly, to a wireless communication method, a user equipment, and a base station.

### BACKGROUND

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

In LTE and NR, a multi-TRP (Transmission/Reception Point) allows a base station to use multiple transmit/receive antenna panels. This feature is also commonly known as Multiple Input Multiple Output (MIMO). Multiple-TRP configurations are applicable to both downlink (base station to user equipment) and uplink (user equipment to base station) transmissions, enabling bidirectional enhancements in a system.

### SUMMARY

An object of the present disclosure is to propose a user equipment, a base station, and wireless communication method.

Some embodiments of the present disclosure provide a wireless communication method executable in a user equipment (UE), comprising:
receiving a first uplink scheduling and a second uplink scheduling; and
performing a first uplink transmission using the first uplink scheduling and a second uplink transmission using the second uplink scheduling, wherein the first uplink transmission and the second uplink transmission are simultaneously transmitted via multiple transmit panels.

Some embodiments of the present disclosure provide a user equipment (UE) comprising a processor configured to call and run a computer program stored in a memory, to cause a device in which the processor is installed to perform: receiving a first uplink scheduling and a second uplink scheduling; and performing a first uplink transmission using the first uplink scheduling and a second uplink transmission using the second uplink scheduling, wherein the first uplink transmission and the second uplink transmission are simultaneously transmitted via multiple transmit panels.

Some embodiments of the present disclosure provide a base station comprising a processor configured to call and run a computer program stored in a memory, to cause a device in which the processor is installed to perform: receiving, by a first transmission/reception point (TRP) of the base station, a first uplink transmission on radio resources scheduled in the first uplink scheduling; and receiving, by a second TRP of the base station, a second uplink transmission on radio resources scheduled in the second uplink scheduling.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field may obtain other figures according to these figures without paying the premise.

FIG. 1 illustrates a schematic view of a telecommunication system.

FIG. 2 illustrates a schematic view of a user equipment (UE) and a base station.

FIG. 3 illustrates a schematic view showing an embodiment of a wireless communication method.

FIG. 4 illustrates a schematic view showing another example of multi-TRP-based non-coherent joint transmission.

FIG. 5 illustrates a schematic view showing another example of multi-TRP transmission.

FIG. 6 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Abbreviations used in the description are listed in the following:

TABLE 1

| | |
|---|---|
| 3GPP | 3^{rd} Generation Partnership Project |
| 5G | 5^{th} Generation |
| NR | New Radio |
| gNB | Next generation NodeB |
| DL | Downlink |
| UL | Uplink |
| PUSCH | Physical Uplink Shared Channel |
| PUCCH | Physical Uplink Control Channel |
| PDSCH | Physical Downlink Shared Channel |
| PDCCH | Physical Downlink Control Channel |
| SRS | Sounding Reference Signal |
| RS | Reference Signal |
| CORESET | Control Resource Set |
| DCI | Downlink control information |
| TRP | Transmission/reception point |
| RRC | Radio Resource Control |
| HARQ | Hybrid Automatic Repeat Request |
| NW | Network |
| TCI | Transmission Configuration Indicator |
| Tx | Transmission |
| Rx | Receive |
| QCL | Quasi co-location |

This present disclosure provides solutions for transmitting multiple physical uplink shared channel (PUSCH) simultaneously by a UE.

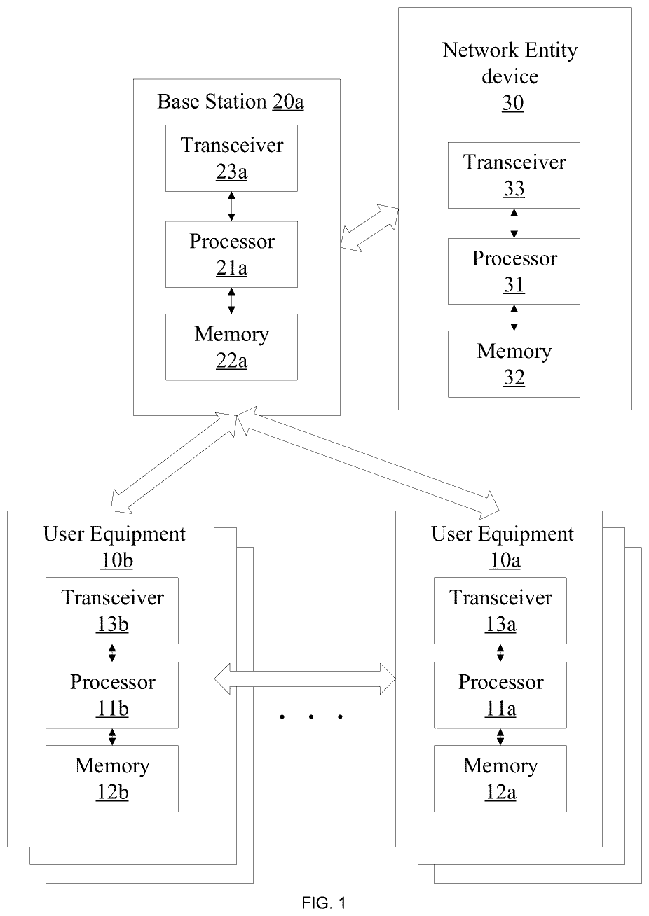

With reference to FIG. 1, a telecommunication system including a UE 10a, a UE 10b, a base station (BS) 20a, and a network entity device 30 executes the disclosed method according to an embodiment of the present disclosure. FIG. 1 is shown for illustrative not limiting, and the system may comprise more UEs, BSs, and CN entities. Connections between devices and device components are shown as lines and arrows in the FIGs. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, transmits and/or receives radio signals or wireline signals. The UE 10a may be in communication with the UE 10b or other UEs. The base station 20a may be an eNB, a gNB, or one of other types of radio nodes, and may configure radio resources for the UE 10a and UE 10b.

Each of the processors 11a, 11b, 21a, and 31 may include an application-specific integrated circuit (ASICs), other chipsets, logic circuits and/or data processing devices. Each of the memory 12a, 12b, 22a, and 32 may include read-only memory (ROM), a random access memory (RAM), a flash memory, a memory card, a storage medium and/or other storage devices. Each of the transceivers 13a, 13b, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

The network entity device 30 may be a node in a CN. CN may include LTE CN or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

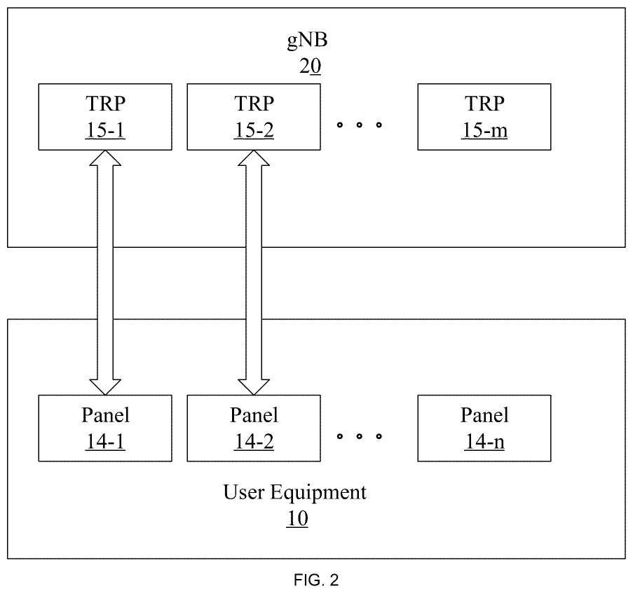

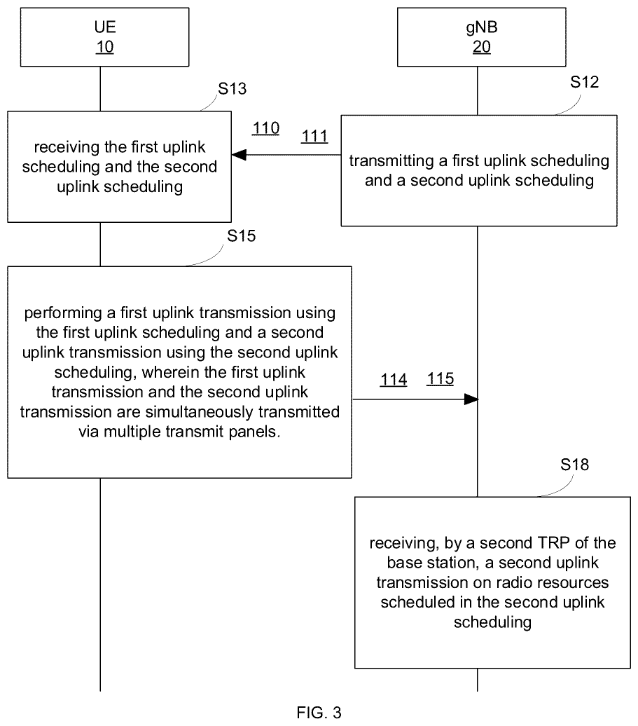

An example of the UE in the description may include one of the UE 10a or UE 10b. An example of the base station in the description may include the base station 20a. With reference to FIG. 2 to FIG. 3, for example, an embodiment of a UE 10 includes one of the UE 10a or UE 10b, an embodiment of a gNB 20 includes the base station 20a. Although the UE 10 and the gNB 20 is detailed as an example in the description, the disclosed method may be applied to other UEs and/or other base stations. Uplink (UL) transmission of a control signal or data may be a transmission operation from a UE to a base station. Downlink (DL) transmission of a control signal or data may be a transmission operation from a base station to a UE.

In FIG. 2, the UE 10 has multiple panels, including panels 14-1, 14-2, . . . and 14-n. The variable n is a positive integer. A transceiver of the UE 10 is connected to the panels. Each of the panel may comprise one or more antennas or one or more antenna arrays. The gNB 20 has multiple TRPs, including TRPs 15-1, 15-2, . . . and 15-m. The variable m is a positive integer. A transceiver of the gNB 20 is connected to the TRPs. Each of the TRP may comprise one or more antennas or one or more antenna arrays.

In FIG. 3, the UE 10 and the gNB 20 execute an embodiment of a wireless communication method.

The gNB 20 transmits a first uplink scheduling 110 and a second uplink scheduling 111 to the UE 10 (S12). The UE 10 receives the first uplink scheduling 110 and the second uplink scheduling 111 (S13) and transmits uplink transmission according to the first uplink scheduling 110 and the second uplink scheduling 111.

Specifically, the UE 10 performs a first uplink transmission 114 using the first uplink scheduling 110 and a second uplink transmission 115 using the second uplink scheduling 111, wherein the first uplink transmission 114 and the second uplink transmission 115 are simultaneously transmitted via multiple transmit panels (S15).

The gNB 20 receives, by a first transmission/reception point (TRP) of the base station gNB 20, the first uplink transmission 114 on radio resources scheduled in the first uplink scheduling 110 and receives, by a second TRP of the base station gNB 20, the second uplink transmission 115 on radio resources scheduled in the second uplink scheduling 111. The first TRP is abbreviated as TRP1, and the second TRP is abbreviated as TRP 2. An example of the first TRP includes TRP 14-1, and an example of the second TRP includes TRP 14-2.

In some embodiments, the first uplink transmission 114 is a first physical uplink shared channel (PUSCH) transmission, and the second uplink transmission 115 is a second PUSCH transmission. The first PUSCH transmission and the second PUSCH transmission exhibit either full or partial overlap in a time domain, as well as full or partial overlap, or no overlap, in a frequency domain. The first PUSCH transmission is codebook-based or non-codebook-based transmission, and the second PUSCH transmission is codebook-based or non-codebook-based transmission.

In some embodiments, the first uplink scheduling 110 comprises a first sounding reference signal (SRS) resource set configured for the first PUSCH transmission, and the second uplink scheduling 111 comprises a second SRS resource set configured for the second PUSCH transmission. Each SRS resource set may have an identifier (ID) or an index, such as SRS-ResourceSet, SRS-ResourceSetId, SRS-PosResource-r16, SRS-PosResourceSetId-r16, SRS-Resource, or SRS-ResourceId. The first SRS resource set is configured with a parameter “usage” set to either codebook-based or non-codebook-based. The second SRS resource set is configured a parameter “usage” set to either codebook-based or non-codebook-based. The first SRS resource set is associated with a first CORESETPoolIndex value, while the second SRS resource set is associated with a second CORESETPoolIndex value.

In some embodiments, the first uplink scheduling 110 comprises a first joint transmission configuration indicator (TCI) state or a first UL TCI state configured for the first uplink transmission 114 associated with a first CORESETPoolIndex value. The second uplink scheduling 111 comprises a second joint TCI state or a second UL TCI state configured for the second uplink transmission 115 associated with a second CORESETPoolIndex value. The first joint TCI state or the first UL TCI state is applied to the first SRS resource set. The second joint TCI state or the second UL TCI state is applied to the second SRS resource set. Configuration of SRS resources set may be included in a parameter or an information element (IE), such as SRS-Resource, SRS-PosResource, and SRS-Config, transmitted in a DL control signal. Configuration of joint TCI state or UL TCI state be included in a parameter or an information element (IE), such as srs-TCI-State, transmitted in a DL control signal.

In some embodiments, for a Type 1 PUSCH transmission with a configured grant, an SRS resource indicator indicates the first SRS resource set or the second SRS resource set, and a joint TCI state or an uplink TCI state is indicated to be applied to the indicated SRS resource set.

In some embodiments, the first uplink scheduling 110 is specified by first downlink control information (DCI) transmitted through a first part of physical downlink control channel (PDCCH), and the second uplink scheduling 111 is specified by second downlink control information (DCI) transmitted through a second part of PDCCH. The first part of PDCCH is associated with a first transmission/reception point (TRP), such as TRP 15-1, and the second part of PDCCH is associated with a second TRP, such as TRP 15-2. For example, the first part of PDCCH referred to as first PDCCH may be transmitted by one TRP, such as TRP 15-1. The second part of PDCCH referred to as second PDCCH may be transmitted by the same TRP or another TRP, such as TRP 15-2.

The first part of PDCCH is located in a first control-resource set (CORESET) with a first CORESETPoolIndex value, and the second part of PDCCH is located in a second CORESET with a second CORESETPoolIndex value.

In some embodiments, for a Type 2 PUSCH transmission with a configured grant:
if one DCI format is in a PDCCH in a CORESET associated with the first CORESETPoolIndex value, the Type 2 PUSCH transmission with a configured grant triggered by the DCI format is also associated with the first CORESETPoolIndex value; and
if one DCI format is in a PDCCH in a CORESET associated with the second CORESETPoolIndex value, the Type 2 PUSCH transmission with a configured grant triggered by the DCI format is also associated with the second CORESETPoolIndex value.

For a Type 2 PUSCH transmission with a configured grant:
if the UE 10 receives one DCI format in a PDCCH in a CORESET associated with the first CORESETPoolIndex value, the UE 10 assumes that the Type 2 PUSCH transmission with a configured grant triggered by the DCI format is also associated with the first CORESETPoolIndex value; and if the UE 10 receives one DCI format in a PDCCH in a CORESET associated with the second CORESETPoolIndex value, the UE 10 assumes that the Type 2 PUSCH transmission with a configured grant triggered by the DCI format is also associated with the second CORESETPoolIndex value.

In some embodiments, for a Type 2 PUSCH transmission with a configured grant, one SRS resource set is indicated according to an association between a CORESETPoolIndex value and a PDCCH where a corresponding DCI format is received, and the DCI format triggers the Type 2 PUSCH transmission with a configured grant and schedules the SRS resource set for the Type 2 PUSCH transmission with a configured grant.

In some embodiments, for a Type 2 PUSCH transmission with a configured grant, the UE determines one SRS resource set according to an association between a CORESETPoolIndex value and a PDCCH where a corresponding DCI format is received, and the DCI format triggers the Type 2 PUSCH transmission with a configured grant and schedules the SRS resource set for the Type 2 PUSCH transmission with a configured grant.

NR system introduces multi-TRP-based non-coherent joint transmission. Multiple TRPs are connected through backhaul link for coordination. The backhaul link can be ideal or non-ideal backhaul. In the case of an ideal backhaul, the TRPs can exchange dynamic physical downlink shared channel (PDSCH) scheduling information with short latency. Thus, the different TRP can coordinates the PDSCH transmission for each individual PDSCH transmission. On the other hand, in a non-ideal backhaul case, the information exchange between TRPs experience significant latency. Consequently, the coordination between TRPs can only be semi-static or static.

In non-coherent joint transmission, different TRPs use different PDCCHs to schedule the PDSCH transmissions independently. Each TRP can send a single DCI to schedule one PDSCH transmission. PDSCHs from different TRPs can be scheduled in same or different slots. Two different PDSCH transmission from different TRPs can either be completely overlapped or partially overlapped in PDSCH resource allocation.

To support multi-TRP based non-coherent joint transmission, a UE is requested to receive PDCCHs from multiple TRPs and subsequently receive PDSCHs sent from multiple TRPs. For each PDSCH transmission, the UE can provide feedback in form of a hybrid automatic repeat request-acknowledgment (HARQ-ACK) information to the network. In multi-TRP transmission, the UE can provide the HARQ-ACK information for each PDSCH transmission to the TRPs that transmit the PDSCHs. The UE can also provide the HARQ-ACK information for a PDSCH transmission sent from any TRP to one particular TRP.

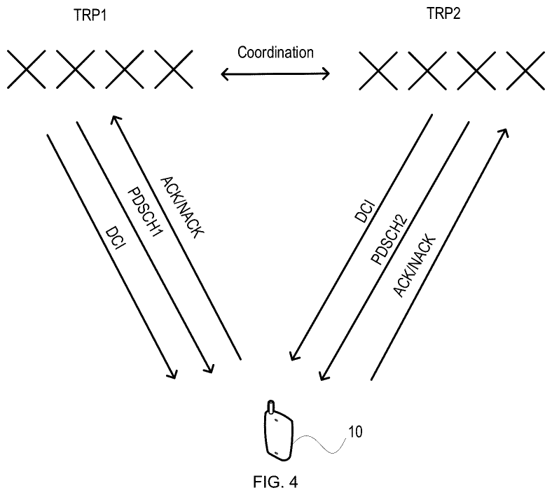

FIG. 4 illustrates an example of multi-TRP-based non-coherent joint transmission. In this scenario, a UE receives PDSCH transmissions based on non-coherent joint transmission from two TRPs: TRP1 and TRP2. As shown in the FIG. 4, the TRP1 sends a single DCI to schedule the transmission of PDSCH1 to the UE, while TRP2 sends a separate DCI to schedule the transmission of PDSCH2 to the UE. At the UE side, the UE receives and decodes DCIs from both TRPs. Based on the DCI from TRP1, the UE receives and decodes PDSCH1 and based on the DCI from TRP2, the UE receive and decodes PDSCH2.

In the example shown in FIG. 4, the UE reports HARQ-ACK for PDSCH1 to the TRP1 and HARQ-ACK for PDSCH2 TRP 2. TRP1 and TRP 2 use different CORESETs and search spaces to transmit DCI for scheduling PDSCH transmissions to the UE. Therefore, the network (NW) can configure multiple CORESETs and search spaces. Each TRP can be associated with one or more CORESETs and the related search spaces. With this configuration, the TRP would use the associated CORESET to transmit, to the UE, DCI that schedule a PDSCH transmission to the UE. The UE can be requested to decode DCIs in CORESETs associated with the TRPs to obtain PDSCH scheduling information.

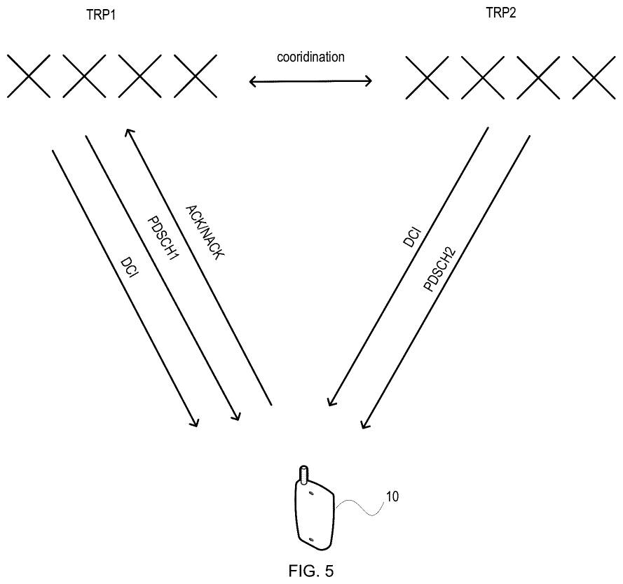

FIG. 5 illustrates another example of multi-TRP transmission. In this scenario, a UE receives PDSCH transmissions based on non-coherent joint transmission from two TRPs: TRP1 and TRP2. As shown in the FIG. 5, the TRP1 sends a single DCI to schedule the transmission of PDSCH1 to the UE, while TRP2 sends a single DCI to schedule the transmission of PDSCH2 to the UE. At the UE side, the UE receive and decode the DCIs from both TRPs. Based on the DCI from TRP1, the UE receives and decodes PDSCH1. Based on the DCI from TRP2, the UE receives and decodes PDSCH2. In the example shown in FIG. 5, the UE reports HARQ-ACK for both PDSCH1 and PDSCH2 to the TRP1. By relaying the HARQ-ACK through the ideal backhaul connecting the TRP1 and TRP2, both of the TRP1 and TRP2 receives the HARQ-ACK. This differs from the HARQ-ACK reporting in the example shown in FIG. 4. It is important to note that the example depicted in FIG. 5 requires an ideal backhaul between TRP 1 and TRP 2, whereas the example shown in FIG. 4 can be deployed in scenarios where the backhaul between TRP1 and TRP2 is either ideal or non-ideal.

The current uplink transmission scheme in a multi-DCI based multi-TRP system has a drawback wherein the UE is unable to simultaneously transmit multiple uplink transmissions to different TRPs. This limitation results in the inefficient utilization of time frequency resources, thereby impairing the system efficiency of the multi-TRP system.

In one embodiment, the gNB can be configured to schedule a UE, so that the UE transmits two PUSCHs that exhibit either full or partial overlap in the time domain, as well as full or partial overlap, or no overlap, in the frequency domain. The gNB sends two separate DCIs to schedule those two PUSCHs that exhibit either full or partial overlap in the time domain, as well as full or partial overlap, or no overlap, in the frequency domain. In other word the gNB can send a first DCI to schedule a first PUSCH and a second DCI to schedule a second PUSCH. The first PUSCH and the second PUSCH can exhibit either full or partial overlap in the time domain, as well as full or partial overlap, or no overlap, in the frequency domain.

The gNB can configure two sounding reference signal (SRS) resource sets for PUSCH transmission. For example, the gNB can configure a first SRS resource set for codebook-based or non-codebook-based PUSCH transmission (referred to as first PUSCH transmission), and the gNB can configure a second SRS resource set for codebook-based or non-codebook-based PUSCH transmission (referred to as second PUSCH transmission). A first PUSCH transmission can be associated with the first SRS resource set, and a second PUSCH transmission can be associated with the second SRS resource set.

The PDCCHs can be categorized and divided into two parts: the first part of the PDCCHs is associated with a first TRP (e.g., TRP1), and the second part of the PDCCHs is associated with a second TRP (e.g., TRP2). The first DCI can be transmitted in any PDCCH in the first part and the second DCI can be transmitted in any PDCCH in the second part.

In one method, the gNB can provide the configuration of multiple Control Resource Sets (CORESETs) for Physical Downlink Control Channel (PDCCH) transmission, where each CORESET can be associated with a high-layer parameter called CORESETPoolIndex, which can be set to either 0 or 1. The gNB can send a first downlink control information (DCI) in a PDCCH associated with a CORESET that is linked to a CORESETPoolIndex set to 0, for the purpose of scheduling a first PUSCH. Similarly, the gNB can transmit a second DCI in a PDCCH associated with a CORESET that is linked to a CORESETPoolIndex set to 1, in order to schedule a second PUSCH. It is important to note that the first PUSCH and the second PUSCH may exhibit either full or partial overlap in the time domain, as well as full or partial overlap, or no overlap, in the frequency domain.

The gNB can configure a first SRS resource set with the parameter “usage” set to either codebook-based or non-codebook-based. Additionally, the gNB can configure a second SRS resource set with the same parameter “usage” set to either codebook-based or non-codebook-based. The first SRS resource set can be associated with the CORESETPoolIndex value of 0, while the second SRS resource set can be associated with the CORESETPoolIndex value of 1.

The gNB can indicate a first joint transmission configuration indicator (TCI) state or a first uplink (UL) TCI state for UL transmission associated with a first TRP (Transmission Reception Point). In other words, the first joint TCI state or the first UL TCI state is configured for UL transmission associated with the CORESETPoolIndex set to 0. Similarly, the gNB can indicate a second joint TCI state or a second UL TCI state for UL transmission associated with a second TRP, where UL transmission is associated with the CORESETPoolIndex set to 1. In other words, the second joint TCI state or the second UL TCI state is configured for UL transmission associated with the CORESETPoolIndex set to 1.

The UE can be instructed to apply the first joint TCI state or UL TCI state to the PUSCH transmission associated with the first TRP, i.e., UL transmission associated with the CORESETPoolIndex set to 0. Likewise, the UE can be instructed to apply the second joint TCI state or UL TCI state to the PUSCH transmission associated with the second TRP, i.e., UL transmission associated with the CORESETPoolIndex set to 1. The gNB may instruct the UE using a configuration or an indication in a downlink control signal.

Furthermore, the UE can be instructed to apply the first joint TCI state or UL TCI state to the SRS resource in the first SRS resource set. Similarly, the UE can be instructed to apply the second joint TCI state or UL TCI state to the SRS resource in the second SRS resource set. That is, when transmitting SRS on the SRS resource in the first SRS resource set, the UE applies parameters of the first joint TCI state or UL TCI state for transmission of the SRS. Similarly, when transmitting SRS on the SRS resource in the second SRS resource set, the UE applies parameters of the second joint TCI state or UL TCI state for transmission of the SRS. The gNB may instruct the UE using a configuration or an indication in a downlink control signal.

The first DCI sent in a PDCCH associated with a CORESETPoolIndex set to 0 schedules the transmission of the first PUSCH. In the first DCI, the bit field sounding reference signal resource indicator (SRI) indicates one or more SRS resources in the first SRS rescore set. The second DCI sent in a PDCCH associated with a CORESETPoolIndex set to 1 schedule the transmission of the second PUSCH. In the second DCI, the bit field SRI indicates one or more SRS resources in the second SRS rescore set.

In one example, the SRS resource indicator (SRI) field within the DCI can provide an indication of whether the SRS resource(s) indicated by the SRI field are derived from the first SRS resource set or the second SRS resource set.

For example, if PUSCH transmission associated with the first SRS resource set and the second SRS rescore set are not configured to follow the indicated unified TCI state, the DCI field “SRS resource indicator” can indicate whether the SRS resource(s) indicated by the SRI field are derived from the first SRS resource set or the second SRS resource set.

If the first PUSCH and the second PUSCH partially or fully overlap in time domain, the UE shall expect that the first DCI and the second DCI indicates different SRS resource sets.

TCI states are defined in TS 38.214.

The PUSCH resource allocation can be semi-statically configured by higher layer parameter through radio resource control (RRC) signaling. The PUSCH transmission corresponding to a configured grant.

In an embodiment of the disclosed method, the UE can be configured with a Type 1 PUSCH transmission with a configured grant. Type 1 PUSCH transmission with a configured grant is PUSCH transmission using configured grant Type 1 as defined in 3GPP related standards, such as technical specification (TS) 38.321.

In an example where the higher layer parameter (e.g., RRC signaling) provides the configuration of a Type 1 PUSCH transmission with a configured grant, the UE can be provided with an SRS resource indicator that indicates the first SRS resource set or the second SRS resource set. The term “indicated SRS resource set” refers to either the first SRS resource set or the second SRS resource set that has been specified or indicated.

For the Type 1 PUSCH transmission with a configured grant, the UE can be instructed to use which one of the indicated joint TCI states or UL TCI states. The term “indicated joint TCI state or UL TCI state” refers to either the first joint TCI state or UL TCI state or the second joint TCI state or UL TCI state that has been specified or indicated for or associated with the indicated SRS resource set.

In one example, for a Type 1 PUSCH transmission with a configured grant, the UE can be provided with an SRS resource indicator that indicates the first SRS resource set or the second SRS resource set. The UE can be requested to apply the joint TCI state or UL TCI state, which is indicated to be applied to indicated SRS resource set, to the PUSCH transmission.

In one example, for a Type 1 PUSCH transmission with a configured grant, the UE can be provided with association that associates a joint TCI state or UL TCI state with one of the first SRS resource set or the second SRS resource set. When the first SRS resource set and the second SRS resource set are associated with the same joint TCI state or UL TCI state, the UE can be requested to assume that the PUSCH is associated with the one of the first SRS resource set or the second SRS resource set.

In one example, for a Type 1 PUSCH transmission with a configured grant, the UE can be provided with an association that associates a joint TCI state or UL TCI state with a CORESETPoolIndex value 0 or 1 or associates a PUSCH transmission with a CORESETPoolIndex value 0 or 1. For example, a first Type 1 PUSCH transmission with a configured grant can be associated with CORESETPoolIndex=0. For example, a second Type 1 PUSCH transmission with a configured grant can be associated with CORESETPoolIndex=1. In performing a Type 1 PUSCH transmission with a configured grant associated with a CORESETPoolIndex value, the UE can be requested to apply the indicated joint TCI state or UL TCI state that is associated with the CORESETPoolIndex value of the PUSCH transmission.

In an embodiment of the disclosed method, the UE can be configured with a Type 2 PUSCH transmission with a configured grant, where resource allocation follows the higher layer configuration in RRC and UL grant received in DCI. Type 2 PUSCH transmission with a configured grant is PUSCH transmission using configured grant Type 2 as defined in 3GPP related standards, such as technical specification (TS) 38.321.

The initiation of a Type 2 PUSCH transmission with a configured grant is triggered through a UL grant received in DCI, such as DCI format 0_1 or 0_2. For such a PUSCH transmission, the UE can be requested to assume that this PUSCH transmission is associated with the CORESETPoolIndex value that is associated with the CORESET of PDCCH where the corresponding DCI carrying the UL grant is received. For example, if the UE receives one DCI format in a PDCCH in a CORESET associated with CORESETPoolIndex=0, the UE can assume that the Type 2 PUSCH transmission with a configured grant triggered by the DCI format is also associated with the CORESETPoolIndex=0. For example, if the UE receives one DCI format in a PDCCH in a CORESET associated with CORESETPoolIndex=1, the UE can assume that the Type 2 PUSCH transmission with a configured grant triggered by the DCI format is also associated with the CORESETPoolIndex=1.

For a Type 2 PUSCH transmission with a configured grant, the UE can be requested to determine a corresponding SRS resource set out of the first SRS resource set and the second SRS resource set according to one or more of the following alternatives:
Alt1: The corresponding DCI format can indicate one SRS resource set through the DCI bit field “SRS resource set indicator”.
Alt2: The UE can determine one SRS resource set according to the association between the CORESETPoolIndex value and the PDCCH where the corresponding DCI format is received. The DCI format triggers the Type 2 PUSCH transmission with a configured grant and schedules the SRS resource set for the Type 2 PUSCH transmission with a configured grant.
Alt3: the UE can determine one SRS resource set according to the indicated joint TCI state or UL TCI state that is applied on this PUSCH transmission.

The disclosed method can enable a UE with multiple transmit panels to transmit more than one PUSCH transmission simultaneously and thus the uplink peak throughput can be improved.

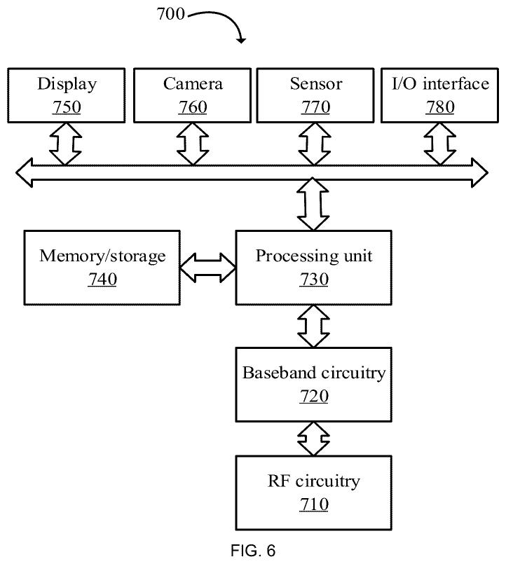

FIG. 6 is a block diagram of an example system 700 for wireless communication according to an embodiment of the present disclosure. Embodiments described herein may be implemented into the system using any suitably configured hardware and/or software. FIG. 6 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for the system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that may be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure may be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments may be integrated into one processing unit, physically independent, or integrated into one processing unit with two or more than two units.

If the software function unit is realized and used and sold as a product, it may be stored in a non-transitory computer-readable storage medium in a computer. Based on this understanding, the technical plan proposed by the present disclosure may be essentially or partially realized as the form of a software product. Or, one part of the technical plan beneficial to the conventional technology may be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

The disclosed method can enable a UE with multiple transmit panels to transmit more than one PUSCH transmission simultaneously and thus the uplink peak throughput can be improved.

At least some embodiments of the disclosed method address the technical problem by enabling simultaneous transmission of multiple uplink transmissions to different TRPs (Transmission/Reception Points) in a multi-TRP system. The benefits of this solution include:

Enhanced system efficiency: By allowing simultaneous uplink transmissions to different TRPs, the solution improves the utilization of time frequency resources. This leads to a more efficient allocation of resources, resulting in increased overall system capacity and improved performance.

Increased throughput: The ability to transmit multiple uplink transmissions simultaneously enables higher throughput for UE. UEs can transmit data to different TRPs concurrently, leading to faster data transfer rates and improved user experience.

Improved resource utilization: By eliminating the limitation of single uplink transmission, the solution optimizes the utilization of available resources. It ensures that time frequency resources are efficiently allocated and reduces resource wastage, resulting in a more effective and economical use of network resources.

Enhanced coverage and connectivity: Simultaneous uplink transmissions to multiple TRPs can improve coverage and connectivity. UEs can transmit to different TRPs simultaneously, which helps in mitigating coverage gaps and improving signal reception at the base station. This benefit is especially important in scenarios where certain areas may have weak signal conditions.

Enhanced spectral efficiency: The efficient utilization of time frequency resources achieved by simultaneous uplink transmissions results in improved spectral efficiency. This means that more data can be transmitted within the same bandwidth, increasing the overall capacity of the system and accommodating more users.

In summary, the solution enables simultaneous uplink transmissions to different TRPs, addressing the current limitation and improving the system efficiency of multi-TRP systems. It enhances resource utilization, throughput, coverage, and connectivity while reducing latency, ultimately leading to a more efficient and capable wireless communication system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method for execution by a user equipment (UE), comprising:
receiving a first uplink scheduling and a second uplink scheduling; and
performing a first uplink transmission using the first uplink scheduling and a second uplink transmission using the second uplink scheduling, wherein the first uplink transmission and the second uplink transmission are simultaneously transmitted via multiple transmit panels.

2. The wireless communication method according to claim 1, wherein the first uplink transmission is a first physical uplink shared channel (PUSCH) transmission, and the second uplink transmission is a second PUSCH transmission.

3. The wireless communication method according to claim 2, wherein the first PUSCH transmission and the second PUSCH transmission exhibit either full or partial overlap in a time domain, as well as full or partial overlap, or no overlap, in a frequency domain.

4. The wireless communication method according to claim 2, wherein the first PUSCH transmission is codebook-based or non-codebook-based transmission, and the second PUSCH transmission is codebook-based or non-codebook-based transmission.

5. The wireless communication method according to claim 3, wherein the first uplink scheduling comprises a first sounding reference signal (SRS) resource set configured for the first PUSCH transmission, and the second uplink scheduling comprises a second SRS resource set configured for the second PUSCH transmission.

6. The wireless communication method according to claim 5, wherein the first SRS resource set is configured with a parameter “usage” set to either codebook-based or non-codebook-based; and
the second SRS resource set is configured a parameter “usage” set to either codebook-based or non-codebook-based.

7. The wireless communication method according to claim 5, wherein the first SRS resource set is associated with a first CORESETPoolIndex value, while the second SRS resource set is associated with a second CORESETPoolIndex value.

8. The wireless communication method according to claim 5, wherein the first uplink scheduling comprises a first joint transmission configuration indicator (TCI) state or a first UL TCI state configured for the first uplink transmission associated with a first CORESETPoolIndex value; and
the second uplink scheduling comprises a second joint TCI state or a second UL TCI state configured for the second uplink transmission associated with a second CORESETPoolIndex value.

9. The wireless communication method according to claim 8, wherein for a Type 1 PUSCH transmission with a configured grant, an SRS resource indicator indicates the first SRS resource set or the second SRS resource set; and
a joint TCI state or an uplink TCI state is indicated to be applied to the indicated SRS resource set.

10. A user equipment (UE) comprising:
a processor configured to execute a computer program stored in a memory, to cause the UE to:
receive a first uplink scheduling and a second uplink scheduling; and
perform a first uplink transmission using the first uplink scheduling and a second uplink transmission using the second uplink scheduling, wherein the first uplink transmission and the second uplink transmission are simultaneously transmitted via multiple transmit panels.

11. The UE according to claim 10, wherein the first uplink scheduling is specified by first downlink control information (DCI) transmitted through a first part of physical downlink control channel (PDCCH); and
wherein the second uplink scheduling is specified by second downlink control information (DCI) transmitted through a second part of PDCCH.

12. The UE according to claim 11, wherein the first part of PDCCH is associated with a first transmission/reception point (TRP), and the second part of PDCCH is associated with a second TRP.

13. The UE according to claim 11, wherein the first part of PDCCH is located in a first control-resource set (CORESET) with a first CORESETPoolIndex value, and the second part of PDCCH is located in a second CORESET with a second CORESETPoolIndex value.

14. The UE according to claim 13, wherein for a Type 2 PUSCH transmission with a configured grant, if the UE receives one DCI format in a PDCCH in a CORESET associated with the first CORESETPoolIndex value, the UE assumes that the Type 2 PUSCH transmission with a configured grant triggered by the DCI format is also associated with the first CORESETPoolIndex value; and
wherein if the UE receives one DCI format in a PDCCH in a CORESET associated with the second CORESETPoolIndex value, the UE assumes that the Type 2 PUSCH transmission with a configured grant triggered by the DCI format is also associated with the second CORESETPoolIndex value.

15. The UE according to claim 13, wherein for a Type 2 PUSCH transmission with a configured grant, the UE determines one SRS resource set according to an association between a CORESETPoolIndex value and a PDCCH where a corresponding DCI format is received, and the DCI format triggers the Type 2 PUSCH transmission with a configured grant and schedules the SRS resource set for the Type 2 PUSCH transmission with a configured grant.

16. A base station comprising:
a processor configured to call and run a computer program stored in a memory, to cause a device in which the processor is installed to perform:
transmitting a first uplink scheduling and a second uplink scheduling;
receiving, by a first transmission/reception point (TRP) of the base station, a first uplink transmission on radio resources scheduled in the first uplink scheduling; and
receiving, by a second TRP of the base station, a second uplink transmission on radio resources scheduled in the second uplink scheduling.

17. The base station according to claim 16, wherein the first uplink transmission is a first physical uplink shared channel (PUSCH) transmission, and the second uplink transmission is a second PUSCH transmission.

18. The base station according to claim 17, wherein the first PUSCH transmission and the second PUSCH transmission exhibit either full or partial overlap in a time domain, as well as full or partial overlap, or no overlap, in a frequency domain.

19. The base station according to claim 17, wherein the first PUSCH transmission is codebook-based or non-codebook-based transmission, and the second PUSCH transmission is codebook-based or non-codebook-based transmission.

20. The base station according to claim 18, wherein the first uplink scheduling comprises a first sounding reference signal (SRS) resource set configured for the first PUSCH transmission, and the second uplink scheduling comprises a second SRS resource set configured for the second PUSCH transmission.
